(19) United States
(12) Patent Application Publication
(10) Pub. No.: US 2024/0061209 A1
(43) Pub. Date: Feb. 22, 2024

(54) ROTATIONAL-BASED ADJUSTABLE OPTICAL MOUNT

(71) Applicant: Quantum-Si Incorporated, Branford, CT (US)

(72) Inventors: Shuo Li, Stamford, CT (US); Ryan Heacox, Newington, CT (US)

(73) Assignee: Quantum-Si Incorporated, Branford, CT (US)

(21) Appl. No.: 18/451,782

(22) Filed: Aug. 17, 2023

Related U.S. Application Data
(60) Provisional application No. 63/399,414, filed on Aug. 19, 2022.

(51) Int. Cl. G02B 7/182; G02B 7/198

(52) U.S. Cl. CPC G02B 7/1821; G02B 7/198

(57) ABSTRACT

The present disclosure provides improvements to adjustable optical mounts that increase the stability of the optical mount alignment while providing for the alignment to be easy adjusted. Various aspects of the present disclosure related to an optical mount for adjusting the position of an optical component, the optical mount comprising: a front plate comprising a front surface, a back surface, and a shaft, wherein the front surface is configured to support the optical component, and the shaft extends from the back surface of the front plate; and a base comprising a bore, wherein the bore is configured to receive the shaft of the front plate such that the front plate is configured to rotate around an axis of rotation of the front plate that is aligned with the shaft.

### RELATED APPLICATIONS

This application claims priority under 35 U.S.C. § 119(e) to U.S. Provisional Application Ser. No. 63/399,414, filed Aug. 19, 2022, under Attorney Docket No. R0708.700151US00, and titled, “ROTATIONAL-BASED ADJUSTABLE OPTICAL MOUNT,” which is herein incorporated by reference in its entirety.

### FIELD OF THE DISCLOSURE

The present disclosure relates to optical component mounts.

### BACKGROUND

Optical mounts that support optical components for use in optical configurations and measurements would benefit from improvement.

### SUMMARY OF THE DISCLOSURE

An optical mount for adjusting the position of an optical component, the optical mount comprising: a front plate comprising a front surface, a back surface, and a shaft, wherein the front surface is configured to support the optical component, and the shaft extends from the back surface of the front plate; and a base comprising a bore, wherein the bore is configured to receive the shaft of the front plate such that the front plate is configured to rotate around an axis of rotation of the front plate that is aligned with the shaft.

A method of manufacturing an optical mount, the method comprising: forming a front plate comprising a front surface, a back surface, and a shaft, wherein the front surface is configured to support an optical component, and the shaft extends from the back surface of the front plate; and forming a base comprising a bore, wherein the bore is configured to receive the shaft of the front plate such that the front plate is configured to rotate around an axis of rotation of the front plate that is aligned with the shaft.

A method for adjusting the position of an optical component that is supported by an optical mount, the optical mount comprising a front plate, and a base configured to support the front plate, the method comprising: adjusting a vertical angle of an optical axis of the optical component, relative to an axis of rotation of the front plate, by rotating the front plate relative to the base; and adjusting a horizontal angle of the optical axis of the optical component, relative to an axis of rotation of the base, by rotating the base.

A beam-shaping and steering assembly for altering a beam of radiation, the assembly comprising an optical mount for adjusting the position of an optical component to adjust a pointing of an input beam into beam shaping and steering optics, the optical mount comprising: a first optical component mounted on a first optical mount comprising: a front plate comprising a front surface, a back surface, and a shaft, wherein the front surface is configured to support the first optical component, and the shaft extends from the back surface of the front plate; and a base comprising a bore, wherein the bore is configured to receive the shaft of the front plate such that the front plate is configured to rotate around an axis of rotation of the front plate that is aligned with the shaft.

The foregoing summary is not intended to be limiting. Moreover, various aspects of the present disclosure may be implemented alone or in combination with other aspects. Further, the features described in connection with one exemplary embodiment may be incorporated in other embodiments.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being place on illustrating various aspects of the techniques and devices described herein. In the drawings:

FIG. 1 illustrates a schematic view of an optical mount with a rotatable front plate, in accordance with some embodiments.

FIG. 2A illustrates a perspective view of the front of the optical mount of FIG. 1, in accordance with some embodiments.

FIG. 2B illustrates a perspective view of the back of the optical mount of FIG. 1, in accordance with some embodiments.

FIG. 3A illustrates a schematic to represent adjusting the front plate alignment in a horizontal direction, in accordance with some embodiments.

FIG. 3B illustrates a schematic to represent adjusting the front plate alignment in a vertical direction, in accordance with some embodiments.

FIG. 4A illustrates a top view of an optical mount, in accordance with some embodiments.

FIG. 4B illustrates a cross sectional view along line I of the optical mount shown in FIG. 4A.

FIG. 4C illustrates a cross sectional view along line II of the optical mount shown in FIG. 4A.

FIG. 5A illustrates an optical mount configured with a tilt angle of 45 degrees, in accordance with some embodiments.

FIG. 5B illustrates an optical mount configured with a tilt angle of 2 degrees, in accordance with some embodiments.

FIG. 6A illustrates an optical mount configured with a transmissive front plate, in accordance with some embodiments.

FIG. 6B illustrates an optical mount in a reflective geometry, in accordance with some embodiments.

FIG. 6C illustrates a ray diagram of the optical mount in the reflective geometry of FIG. 6B, in accordance with some embodiments.

FIG. 6D illustrates an optical mount in a transmissive geometry, in accordance with some embodiments.

FIG. 6E illustrates a ray diagram of the optical mount in the transmissive geometry of FIG. 6C, in accordance with some embodiments.

FIG. 7 illustrates the coupling between vertical and horizontal adjustments for an exemplary optical mount with a 45-degree tilt angle, in accordance with some embodiments.

FIG. 8 illustrates the vertical angle of a reflected beam for two exemplary optical mounts, in accordance with some embodiments.

FIG. 9 illustrates a beam shaping/steering unit configured with rotation based optical mounts, in accordance with some embodiments.

FIG. 10 illustrates a bio-optoelectronic system including a beam-shaping and steering module configured to couple light pulses from a pulsed laser to a bio-optoelectronic chip, in accordance with some embodiments.

### DETAILED DESCRIPTION

The present disclosure provides improvements to adjustable optical mounts to increase the stability of optical mount alignment while providing for the alignment to be easily adjusted. According to some aspects of the present disclosure, rotating a front plate of the optical mount, relative to the base, may vertically adjust the alignment of reflected light. According to some aspects of the present disclosure, an optical mount includes a base which may be rotated to horizontally adjust the alignment of reflected light.

Optical applications which rely on light for performing measurements or transmitting signals may be highly sensitive to the alignment of its optical paths. Optical paths are trajectories along which light beams are transmitted. Optical components such as minors and lenses are used to control the properties of the light beam—such as the direction, shape, size, and convergence of the light beam. However, the position of optical components, relative to the propagation of a light beam, may have a large impact on the resulting properties of the light beam. Therefore, optical mounts are used to position optical components such that they are configured to direct light from an input or source to an output or target.

The inventors have recognized and appreciated that existing optical mounts would benefit from increased stability in the positioning of optical components while maintaining an easily adjustable alignment of the optical component to control the size, shape, and/or propagation direction of light beams. light beam paths use optical components to reflect, transmit, and/or refract portions of the light. As the impact of optical components on a propagating light beam may depend not only on the angle of the light beam, relative to an optical axis of the optical component, but the alignment of an optical path may have a significant impact on the size, shape, and/or propagation direction of light beams.

The orientation of an optical component may be described by the direction of its optical axis. The optical axis of an optical component is the axis which intersects the center of the optical component at an angle normal with the surface at the center of the optical component.

To control the alignment of optical components in the optical path, optical mounts are used to support optical components. For example, optical mounts may support optical components, such as mirrors, filters, and lenses to affect the propagation of light in the optical path. For many applications, the application sensitivity may be highly sensitive to the alignment of the optical path. Accordingly, even a drift of a few millimeters can dramatically change or compromise the performance of an optical path. Therefore, the stability of an optical mount in maintaining the position of an optical component may be a limiting factor in the stability of an optical path.

Optical mounts may include mechanical components that are configured to adjust the positioning of an optical component to tilt its optical axis and impact the propagation of light beams from the optical component. However, mechanical components may be subject to mechanical drift which may cause the alignment of an optical path to shift, which may introduce errors or noise into measurements that rely on the optical path. Similarly, thermal expansion may impact the stability of the optical mount when the expansion causes the angle or position of the optical component to change. The inventors have recognized and appreciated that existing optical mounts fail to provide both stability and easy adjustability.

For example, fixed mounts provide a high degree of stability, however fixed mounts are time consuming to adjust. To adjust the positioning of fixed mounts, shims are typically placed between the base of the mount and the surface to which the mount is attached. Shims, such as thin metal strips, are fixed in thickness. To adjust a fixed mount using a shim, different shims, or combinations of shims, are positioned under the base and then the alignment is checked before changing the shim or combination of shims. As a result, the alignment of fixed mounts may be very time consuming. When the time to adjust the alignment of the optical components is long, it may prohibit accurate measurements from being made when the source of mechanical vibrations and/or thermal expansion causes significant drift which impacts measurement performance.

As another example, kinematic and flexure mounts are significantly easier to align, relative to fixed mounts. Kinematic and flexure mounts may include mechanical components configured to adjust the optical axis of a mounted optical component. The mechanical components may include screws configured to adjust the tilt of a mounted optical component by exerting pressure to cause the mounting surface to pivot around fixed points. In flexure mounts, these adjustment screws exert forces opposed by a flexure connection between the mounting surface and the base. Similarly, kinematic mounts use adjustment screws to tilt the mounting surface around a pivot such as a ball bearing. However, flexure and kinematic mounts include multiple moving components and components under tension which make them more susceptible to thermal and mechanical fluctuations, resulting in an increased drift of light beams over time relative to fixed mounts under similar conditions.

The inventors have recognized and appreciated the challenges with providing an optical mount with high stability that may also be easily adjusted. Accordingly, the inventors have developed optical mounts that provide an easily adjustable, highly stable optical mount. In accordance with some embodiments, the optical mount includes a front plate, which is configured to support an optical component, and a base which is configured to support the front plate. To adjust the positioning of the optical component the front plate may be rotated relative to the base around an axis of rotation. The optical axis of the optical component may be tilted between 0 and 90 degrees relative to the axis of rotation, as described herein.

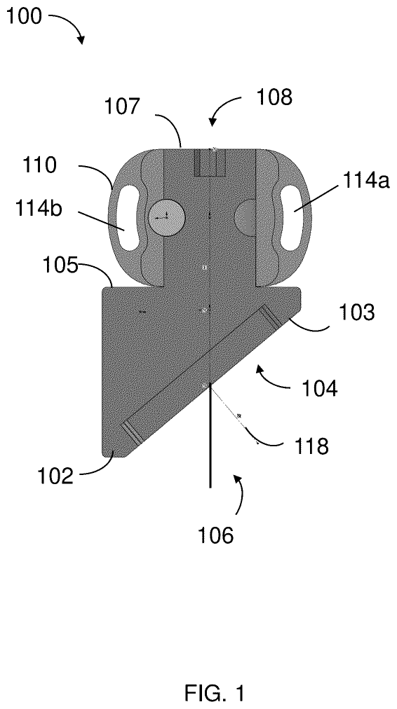

FIG. 1 illustrates a schematic view of an optical mount 100 with a rotatable front plate, in accordance with some embodiments described herein. Optical mount 100 is configured to adjust the position of an optical component supported by the rotatable front plate. The rotatable front plate is configured such that rotation of the front plate adjusts the position of the optical component. When configured in an optical path, rotation of the front plate may be used to adjust the optical alignment of a light beam by adjusting the positioning of the optical component.

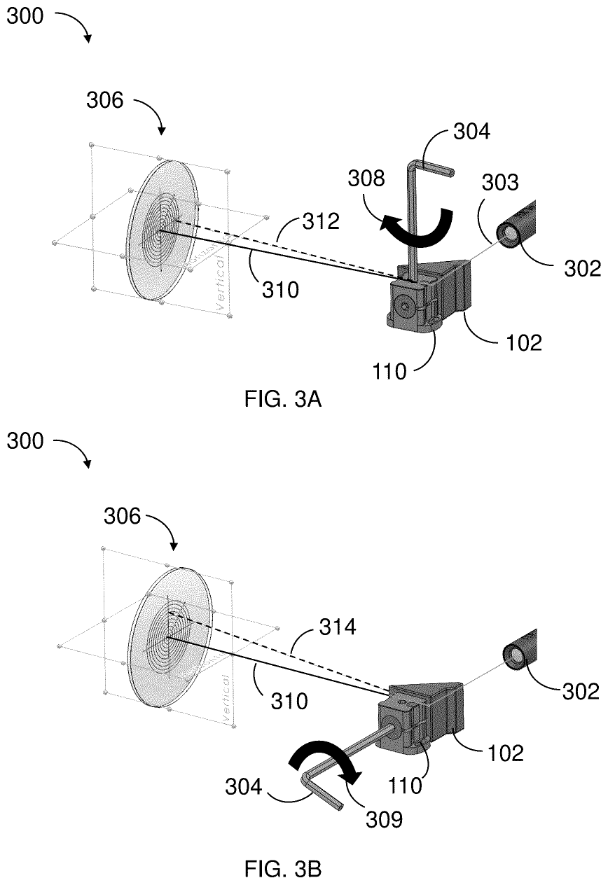

In the illustrated embodiment shown in FIG. 1, optical mount 100 includes front plate 102 and base 110. Front plate 102 is configured to support an optical component such that an optical axis 118 of the optical component is positioned at a tilt angle 106 relative to the axis of rotation. When front plate 102 is rotated, the optical axis 118 of the optical component rotates around the axis of rotation. Rotations of the optical axis change the relative angle between the surface of the optical component and an incoming light beam, which may change the alignment of the reflected light beam as described in further detail below with reference to FIG. 3.

Referring again to FIG. 1, base 110 is configured to support front plate 102 such that front plate 102 may be rotated around an axis of rotation 108. To facilitate rotation of the front plate, base 110 includes a bore configured to receive shaft 107 of the front plate 102 such that the base supports shaft 107. In some embodiments, shaft 107 extends from back surface 105 of the front plate. For example, shaft 107 and the bore are cylindrical such that shaft 107 may rotate around its central axis 108 while the shaft is disposed in the bore. In other embodiments, the shaft and the bore may be other shapes which allow the shaft to rotate within the bore, as aspects of the technology described herein are not limited in this respect. For example, shaft 107 and the bore may be conical.

Although shaft 107 is depicted as being positioned directly behind the optical component in the illustrated embodiment in FIG. 1, other embodiments may include the shaft positioned differently relative to the optical component, as aspects of the technology described herein are not limited in this respect. For example, the shaft may extend from a different surface of the front plate or with an offset relative to the positioning of the optical component. Depending on the configuration of the shaft, the base may be configured to receive the shaft without obstructing access to the optical component.

The base of the optical mount is configured such that the optical mount may be secured within an optical path. In some embodiments, the base may comprise one or more curved slots through which the base may be mounted to a surface or apparatus. As shown in FIG. 1, optical mount 100 includes slots 114a and 114b through which the base may be mounted to a surface. For example, optical breadboards include threaded holes for receiving threaded bolts. The base may be secured to the optical breadboard by inserting a threaded bolt through one or more curved slots into a threaded hole on the breadboard and tightened to affix the optical mount in place.

In some embodiments, the positioning and curvature of the slots may be configured such that the base may be rotated around a vertical axis of rotation while a first mounting screw is positioned in curved slot 114a, and a second mounting screw is positioned in curved slot 114b. Either, or both, of the mounting screws may be used to mount the base to a surface such that the base is immobilized. However, when each mounting screw is loose, the base may be rotated to adjust the position of the optical component such that the horizontal angle of reflected light relative to the optical axis is adjusted, as further described below with reference to FIG. 3.

The optical component supported by the optical mount may be a minor. As shown in FIG. 1, minor 104 is supported at the front surface 103 of front plate 102. The optical component may be supported by the optical mount using mechanical components. In other embodiments, the optical component may be glued onto the front surface using an optical adhesive. For example, a UV curing optical adhesive may be used to glue the optic to the front plate.

The inventors have recognized and appreciated that where components connect, thermal expansion of the components may generate forces which may change the positioning of the optical mount and by extension the optical alignment. Therefore, the inventors have developed optical mounts which may be assembled from monolithic components to reduce the impact of potential thermal expansion effects. In some embodiments, the optical mount may include a monolithic front plate and a monolithic base to reduce the number of individual components and improve alignment stability. Accordingly, the front plate may be a monolithic component, formed from a single piece of material.

In other embodiments, the front plate may be formed of multiple components. For example, the shaft may be formed separately from the rest of the front plate and attached to the front plate such that the two components are rigidly fixed. In other embodiments, a retaining bolt may be attached to the back of the shaft such that the shaft is retained within the bore and may not be extracted without first removing the retaining bolt.

In other embodiments, the base may be formed of multiple pieces such that a top and a bottom portion of the base are separate and may be tightened around shaft 107 by tightening a screw on each side of the bore.

The cylindrical shaft may have additional structures to retain the shaft within the bore. For example, a slot may be included in the shaft which is configured to receive tabs extending from the bore into the slot to retain the shaft within the base. As another example, the shaft and bore may be threaded such that the front plate may be screwed into the base.

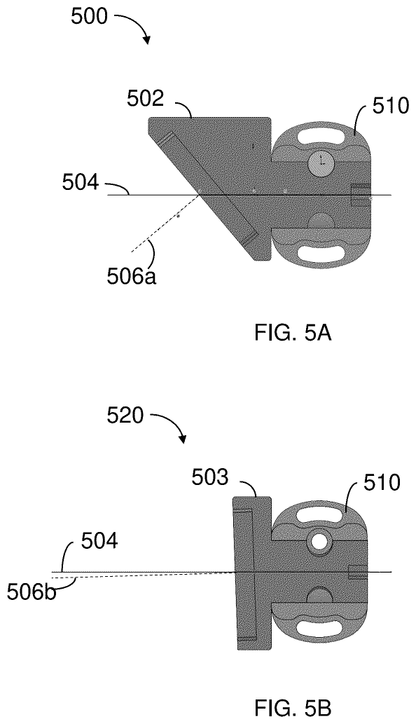

The sensitivity of the optical mount to adjust the pointing of an incident light beam of adjustment to an incident beam may be determined by the tilt angle of the front surface. In some embodiments, the tilt angle is greater than 0 degrees and less than 90 degrees relative to the axis of rotation. In some embodiments, the tilt angle is greater than 25 degrees and less than 65 degrees relative to the axis of rotation. For example, the tilt angle may be 45 degrees as shown in FIG. 1. The sensitivity of the optical mount is further described below, with reference to FIG. 5.

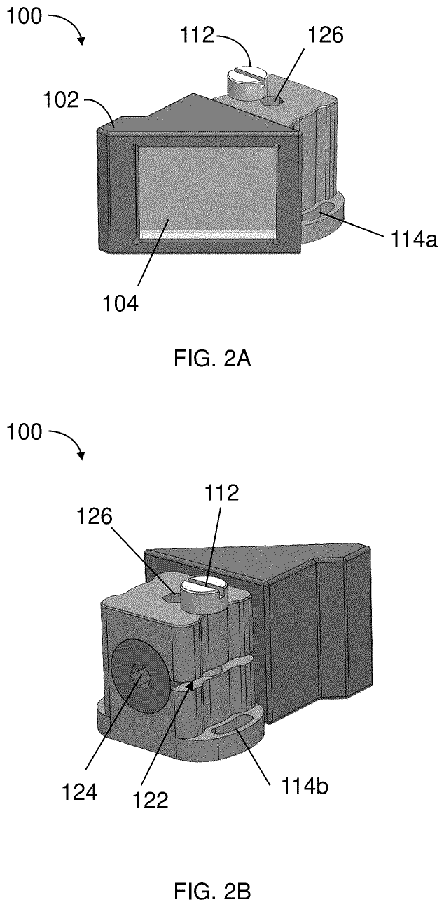

FIG. 2A illustrates a perspective view of the front of optical mount 100, in accordance with some embodiments described herein. The optical mount may be configured to accommodate optics of any size or shape. For example, the optical mount may have an inset corresponding to the shape of the optical component such that the front plate is configured to receive the optical component within the inset. As shown in FIG. 2A, mirror 104 is a rectangular minor that is retained within a rectangular inset in front plate 102. In some embodiments, minor 104 may be a rectangular minor with dimensions of 25 mm by 36 mm at the optical face. In other embodiments, the optical mount may be configured to support circular minors. In other embodiments, square mirrors as aspects of the technology described herein are not limited in this respect.

In other embodiments, curved optics or optical filters may be mounted to the optical mount as aspects of the technology described herein are not limited in this respect. For example, in reflective geometries curved optics including concave minors, convex mirrors, cylindrical minors, or off-axis parabolic minors may be used. As another example, in reflective geometries dichroic minors, dielectric minors, hot/cold mirrors, or band-pass mirrors may be used. In configurations where a portion of the light is expected to transmit through the optic but is not intended to be used, the portion of the front surface that is positioned behind the optical component may be configured as a beam block.

In other embodiments, transmissive geometries may be used. In transmissive geometries, the front plate may be configured with an aperture aligned with the optical axis to allow light which passes through the optical component to be transmitted through the aperture and past the optical mount. For example, dichroic mirrors/filters as described herein, curved optics including concave lenses, convex lenses, and cylindrical lenses may be used.

The optical mount may be configured to facilitate the use of tools in adjusting the position or rotation of the optical mount components. In some embodiments, the optical mount includes a socket on the base which may be used to rotate the base using a driver or wrench. As shown in FIG. 2A, hexagonal socket 126 is disposed in a top surface of the base such that, when the base is not affixed to a surface, a hexagonal ball-driver or a hexagonal wrench may be inserted into the hexagonal socket 126 to rotate facilitate rotation of the base.

FIG. 2B illustrates a perspective view of the back of optical mount 100, in accordance with some embodiments described herein. The inventors have recognized and appreciated that for existing optical mounts, such as flexure mounts, locking the adjustment screws may cause the alignment of the beam to shift. Therefore, the inventors have developed a locking mechanism to restrict the movement of the front plate without causing the alignment of the beam to shift. The optical mount may include a mechanism to restrict the movement of the front plate so that once aligned, the mechanism may be engaged to maintain the alignment of the front plate. As shown in FIG. 2B, the bore may include a notch 122 and a screw 112 such that the bore may operate as a clamp on shaft 107 when screw 112 is tightened, in accordance with some embodiments. Screw 112 may have a slotted screw head as shown in FIG. 2B. In other embodiments, screw 112 may have other screw heads such as Philips, Allen, or any other screw head, as aspects of the technology described herein are not limited in this respect.

In some embodiments, the base may be configured to be rotated by hand. In other embodiments the base may include a mechanical mechanism to facilitate rotation of the base. In yet other embodiments, to facilitate rotation of the front plate, a socket may be included on the shaft which may be used to rotate the front plate. For example, hexagonal socket 124 may be disposed in the back of the shaft 107. A hexagonal ball-driver or a hexagonal wrench may be inserted into the hexagonal socket 124 and turned to rotate the front plate.

FIG. 3A illustrates a schematic to represent adjusting the front plate alignment in a horizontal direction, in accordance with some embodiments described herein. Laser 302 provides a light beam 303 which is reflected off mirror 104. Mirror 104 is mounted to the front surface of front plate 102, as described herein. Base 110 may be rotated to adjust the horizontal pointing of light beam 303. As shown in FIG. 3A, hexagonal wrench 304 is used to rotate base 110 according to arrow 308. As hexagonal wrench 304 is rotated, light beam 303 is horizontally adjusted from alignment 310 to alignment 312.

FIG. 3B illustrates a schematic to represent adjusting the front plate alignment in a vertical direction, in accordance with some embodiments described herein. As in FIG. 3A, laser 302 provides light beam 303 which is reflected off mirror 104 to a target 306. Front plate 102 may be rotated to adjust the vertical pointing of light beam 202. As shown in FIG. 3B, hexagonal wrench 304 is used to rotate front plate 102 according to arrow 309. As hexagonal wrench 304 is rotated, light beam 303 is vertically adjusted from alignment 310 to alignment 314.

The angle of the reflected beam is the angle between the light beam in alignment 314, when the front plate is in a rotated position, relative to the beam in alignment 310 when the front plate is not in a rotated position. In FIGS. 3A and 3B, light beam 303 is parallel with the axis of rotation. However, incoming light beams may have other alignments as aspects of the technology described herein are not limited in this respect.

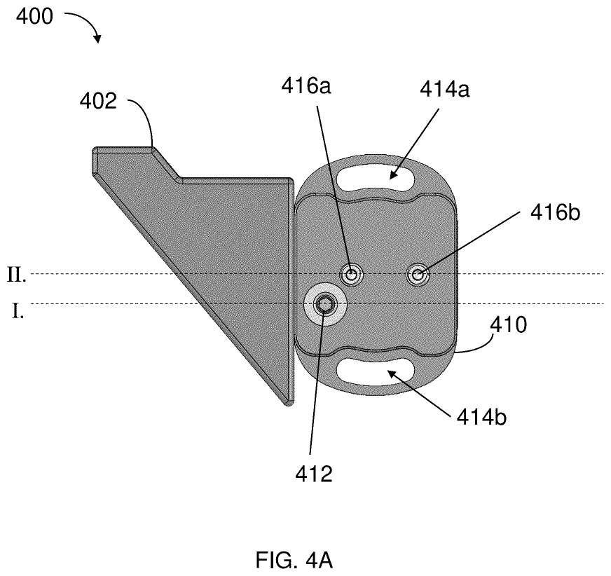

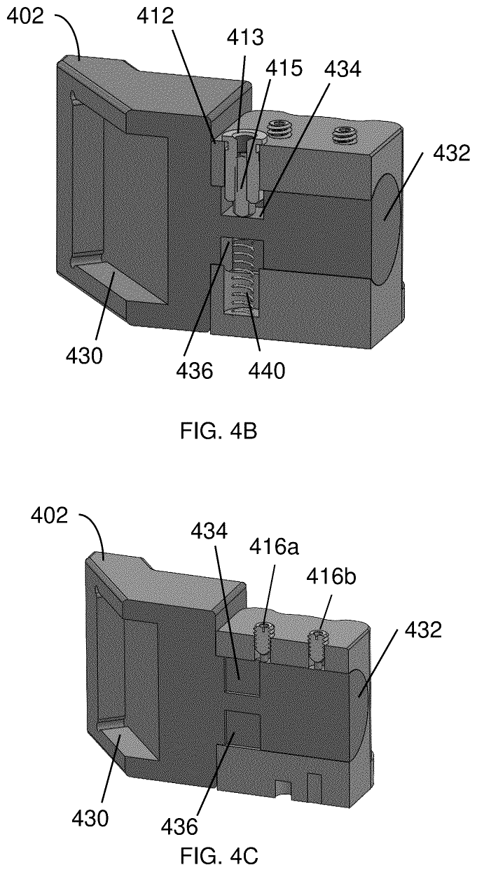

As described above, optical mounts may include mechanical components configured to facilitate rotation of the front plate, in accordance with some embodiments described herein. FIG. 4A illustrates a top view of optical mount 400, in accordance with some embodiments. Optical mount 400 includes front plate 402, base 410, adjustment screw set 412 curved slots 414a and 414b, and set screws 416a and 416b. Front plate 402 is configured to support an optical component at a tilt angle relative to the axis of rotation of the front plate, as described herein. Curved slots 414a and 414b are disposed on base 410 and configured to accommodate screws to mount optical mount 400 to a surface, as described herein.

The front plate 402 of optical mount 400 is configured to adjust the positioning of an optical component when front plate 402 is rotated, as described herein. To facilitate rotation of the front plate, optical mount 400 includes adjustment screw set 412 configured to adjust the rotation of front plate 402 relative to based 410.

FIG. 4B illustrates a cross sectional view along line I of optical mount 400 shown in FIG. 4A. Front plate 402 includes a front surface 430 configured to support an optical component and shaft 432 that is disposed in a bore of base 410. To facilitate rotation of front plate 402 by adjustment screw set 412, shaft 432 is configured to rotate in response to a linear force applied when the adjustment screw set is tightened. Adjustment screw set 412 includes bushing 413 and adjustment screw 415. Bushing 413 is disposed in base 410 such that the bore of base 410 is accessible from an outer surface of the base. Adjustment screw 415 is disposed in bushing 413 such that adjustment screw 415 abuts a first notch 434 in shaft 432. A second notch 436 is disposed in shaft 432 opposite to the first notch 434 and configured to accommodate spring 440. Spring 440 and notch 436 may be configured to apply force to the shaft to promote contact between first notch 434 and adjustment screw 415. In other embodiments, other mechanical mechanisms may be used to facilitate rotation of the front plate, as aspects of the technology described herein are not limited in this respect.

FIG. 4C illustrates a cross sectional view along line II of optical mount 400 shown in FIG. 4A. In some embodiments, the optical mount may include a set screw configured to restrict the movement of the front plate when the set screw is tightened. In some embodiments, the locking screws are oriented substantially perpendicular to the axis of rotation. The inventors have recognized and appreciated that when the locking screws are substantially perpendicular to the axis of rotations, the net torque applied to the shaft is approximately zero. Therefore, the locking screw may be tightened or loosened without exerting a force on the shaft to cause it to rotate, thus preserving the alignment of the optical component. Optical mount 400 includes set screw 416a and 416b disposed in based 410. As shown in FIG. 4C, the set screws are configured to apply pressure to shaft 432 when tightened. Although shown as disposed on the top of base 410, the set screws may be disposed in other positions as aspects of the technology described herein are not limited in this respect. In some embodiments, different numbers of set screws may be disposed on the base. For example, a single set screw may be disposed in the base. As another example, multiple set screws may be disposed on the base.

The inventors have recognized and appreciated that for some applications a more sensitive optical mount may be provide advantages to the precision of adjustment while for other applications a less sensitive optical mount may provide advantages to the range of adjustment. Accordingly, the inventors have developed optical mounts with different vertical sensitivity, in accordance with aspects of the technologies described herein.

In some embodiments, the tilt angle between the axis of rotation and the optical axis may be greater than 0 degrees and less than 90 degrees. In some embodiments, the tilt angle is greater than 25 degrees and less than 65 degrees. For example, in applications which are more susceptible to alignment drift, either due to long optical paths, temperature fluctuations, or mechanical vibrations it may be desirable to use an optical mount that provides a larger range of adjustment. For such applications, an optical mount with a larger tilt angle, such as 45 degrees may be used. As another example, in applications which are more sensitive to precision alignment, it may be desirable to use an optical mount that provides a smaller range of adjustment but a high degree of control over the beam alignment. For such applications, an optical mount with a smaller tilt angle, such as 2 degrees may be used.

The vertical sensitivity of the optical mount is the change in the vertical angle of the reflected beam, relative to the incident beam, as a function of the degree of rotation of the front plate. The vertical sensitivity is described by Equation 1:

$$Vertical Sensitivity = \frac{Angle of Reflected Beam}{Front Plate Rotation Angle} \qquad Equation 1$$

The vertical sensitivity depends on the tilt angle of the front plate. FIG. 5A illustrates optical mount 500 configured with a tilt angle of 45 degrees, in accordance with some embodiments described herein. Optical mount 500 includes front plate 502 and base 510. Front plate 502 is configured to support an optical component such that the tilt angle between the axis of rotation 504 and the optical axis 506a is 45 degrees. In some embodiments, the optical mount has a vertical sensitivity between 0.05 and 1.5.

FIG. 5B illustrates optical mount 520 configured with a tilt angle of 2 degrees, in accordance with some embodiments described herein. Optical mount 520 includes front plate 503 and base 510. Front plate 503 is configured to support an optical component such that the tilt angle between the axis of rotation 504 and the optical axis 506b is 2 degrees.

In some embodiments, the base may be configured such that the front plate is interchangeable. For example, a first front plate may be removed from the base and a second front plate with a different tilt angle may be configured with the base.

The inventors have recognized and appreciated that providing accessibility to the transmitted beam may provide advantages for some applications, such as more compact beam paths and increased versatility of configurations without beam clipping. Therefore, the inventors have developed optical mounts that increase the accessibility of the transmitted beam by configuring the front surface to support the optical component with an offset substantially perpendicular to the optical axis and including an aperture configured behind the optical component.

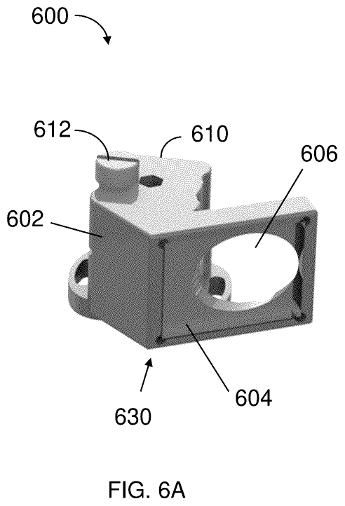

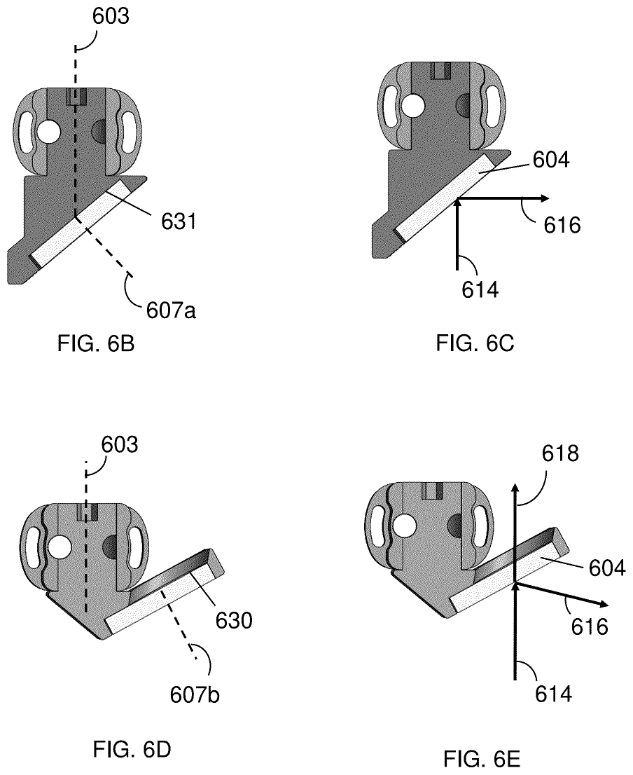

FIG. 6A illustrates optical mount 600 configured with a transmissive front plate, in accordance with some embodiments described herein. Optical mount 600 include front plate 602, base 610, minor 604, and locking screw 612. Front plate 602 includes front surface 630 configured to support minor 604 such that the position of clear aperture 606 enables the transmission of light through the optical mount.

Mirror 604 may be any suitable optical component for a reflective or transmissive optical configuration, as described herein. In some embodiments, the optical component used in a transmissive optical configuration may be a dichroic mirror configured as a long pass filter, a short pass filter, or a bandpass filter, as described herein. When configured with a dichroic mirror, reflected wavelengths of light will be reflected off the front surface of mirror 604 and transmitted wavelengths will transmit through the back surface of mirror 604 and through clear aperture 606. In other embodiments, other partially reflective optical components may be used.

FIG. 6B illustrates an optical mount in a reflective geometry, in accordance with some embodiments described herein. In the reflective geometry shown in FIG. 6B, optical axis 604a intersects rotation axis 603 at front surface 631. The optical mount in may be formed of a metal and/or plastic. In some embodiments, the optical mount may be formed of a material which provides economic, structural, or stability advantages. For example, the optical mount may be formed of aluminum. As another example, the optical mount may be formed of titanium. As yet another example, the optical mount may be formed of a heat-treated stainless steel having a thermal expansion coefficient less than 18×10⁻⁶/K.

FIG. 6C illustrates a ray diagram of the optical mount in the reflective geometry of FIG. 6B, in accordance with some embodiments described herein. In the reflective geometry, an incident light beam 614 is reflected from the surface of the optical component 604 to produce reflected light beam 616.

FIG. 6D illustrates an optical mount in a transmissive geometry, in accordance with some embodiments described herein. In the transmissive geometry shown in FIG. 6D, optical axis 607b is offset from rotation axis 603 at the front surface 630 along a direction substantially perpendicular with optical axis 607. As a result of the offset, the optical path through the clear aperture in the front surface is not obscured by the base or by the shaft of the front plate.

FIG. 6E illustrates a ray diagram of the optical mount in the transmissive geometry of FIG. 6C, in accordance with some embodiments described herein. In the transmissive geometry, the incident light beam 614 may be partially reflected to produce reflected light beam 616. Similarly, the incident light beam 614 may be partially transmitted to produce transmitted light beam 618.

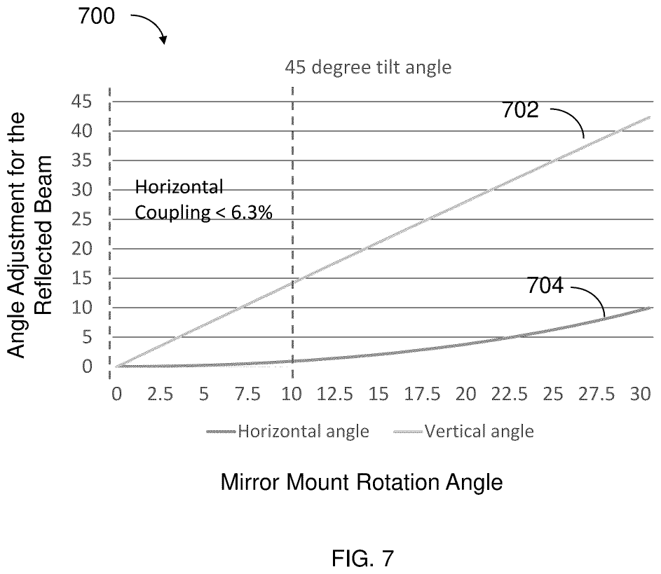

FIG. 7 illustrates the coupling between vertical and horizontal adjustments for an exemplary optical mount with a 45-degree tilt angle, in accordance with some embodiments described herein. Plot 700 illustrates the adjustment to the vertical angle 702 and the horizontal angle 704 of a reflected beam as a function of the rotation angle of the front plate configured with a tilt angle of 45 degrees. As shown in FIG. 7, for a rotation of the front plate less than or equal to 10 degrees, the coupling of the horizontal angle to the vertical angle is less than or equal to approximately 6.3%. For a rotation of the front plate of less than or equal to 30 degrees, the coupling of the horizontal angle to the vertical angle is less than or equal to approximately 23% and greater than or equal to approximately 0.3%. For example, for an optical mount with a front plate that has a 45 degree tilt angle, rotating the front plate approximately 30 degrees results a horizontal adjustment of approximately 9.6 degrees and a vertical adjustment of approximately 41.7 degrees to the horizontal and vertical angles of the optical axis, respectively. As another example, for an optical mount with a front plate that has a 45 degree tilt angle, rotating the front plate approximately 0.5 degrees results in a horizontal adjustment of approximately 0.0022 degrees and a vertical adjustment of approximately 0.7071 degrees to the horizontal and vertical angles of the optical axis, respectively. In other embodiments, the coupling between vertical and horizontal adjustments for an optical mount may be different for an optical mount with a different tilt angle, as described herein.

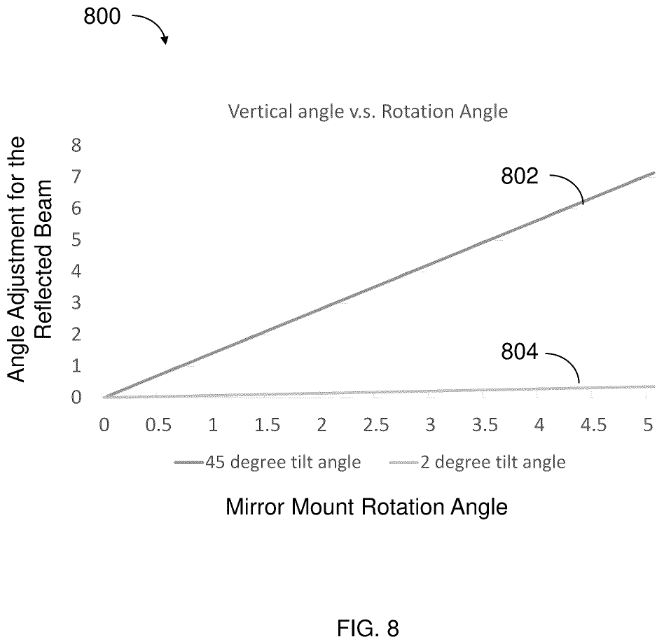

FIG. 8 illustrates the vertical angle of a reflected beam for two exemplary optical mounts, in accordance with some embodiments described herein. Plot 800 illustrates the vertical angle for an optical mount with a 45-degree tilt angle 802 and the vertical angle for an optical mount with a 2-degree tilt angle 804 as a function of the front plate rotation angle. As shown in FIG. 8, optical mounts with a larger tilt angle provide for a larger range of adjustment to the vertical angle relative to optical mounts with a smaller tilt angle.

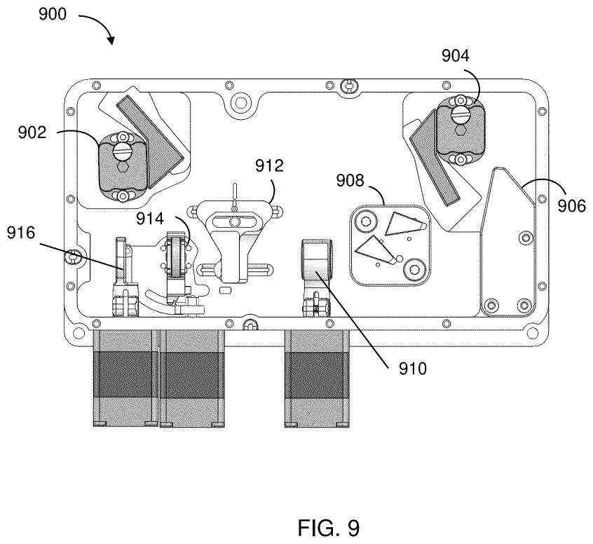

FIG. 9 illustrates a beam shaping/steering unit 900 configured with a rotation based optical mount, in accordance with some embodiments described herein. The beam shaping/steering unit may be configured to adjust the optical properties of light transmitted through the unit in connection with an optical measurement. To facilitate optical measurements, beam shaping/steering units may include optics to adjust the pointing, beam size, beam shape, pulse duration, intensity, and/or spectrum of wavelengths of the light transmitted through the unit. Beam shaping/steering unit 900 includes rotation based optical mounts 902 and 904, prism pair 908, theta y optics 910, lens 912, x-optics 914, and y-optics 916.

Beam shaping/steering unit 900 may be configured to compress or expand the intensity profile of an input beam. In some embodiments, prism pair 908 is configured as an anamorphic prism pair which may be used to compress or expand a dimension of an input light beam's intensity profile. For example, the anamorphic prism pair may be configured to compress the horizontal intensity profile of the input light beam. The amount of compression or expansion may be determined by cut angles between the prism entrance and exit faces through which the light beam transmits.

Optical components may be included to adjust the x and y positioning of the input beam. To aid explanation, a right-hand orthogonal coordinate system XYZ, with the +Z axis pointing in the direction of beam travel and the X axis being perpendicular to the mounting surface is used. In some embodiments, the beam shaping/steering unit includes lenses or windows configured in rotational mounts to adjust the pointing and/or beam angle of the input beam along a horizontal or vertical direction. As shown in FIG. 9, beam shaping/steering unit 900 includes angular adjuster 910, horizontal position adjuster 914, and vertical position adjuster 916. Lens 912 is configured to focus the input beam. Angular adjuster 910 may include a rotational mount configured to rotate a window with respect to the input beam. Rotation of the window changes the angle of the flat surfaces of the window with respect to the input beam. Accordingly, the refraction through the window will change and the position on lens 912 will also change. As the position of the input beam on lens 912 changes the vertical angle of the focused beam may be adjusted. Horizontal position adjuster 914 includes a rotational mount and a second optical window configured to translate the focused beam in a direction parallel to the X axis. Vertical position adjuster 916 includes a rotational mount and a third optical window configured to translate the focused beam in a direction parallel with the Y axis.

In some embodiments, lens 912 may be mounted on a linear translation stage and configured to change the size or ellipticity of the intensity profile by moving lens 912 to change the focusing of the input light beam. In some embodiments, a pair of cylindrical lenses may be used to change the size or ellipticity of the intensity profile.

As the properties of the light transmitted through the beam shaping/steering unit may be highly dependent on the beam alignment into the prism pair, and adjustment optics, precise and stable optical mounts which direct the light beam into the beam prism pair may improve performance of the resulting optical measurements. The rotation based optical mounts provide for quick and easy adjustment of beam alignment for an input beam received by the beam shaping/steering unit 900 and the prism pair 900. In addition to providing easy adjustment of the beam alignment, the optical mounts provide for stable alignment of the light beam to enable improved optical measurements.

A bio-optoelectronic system is a non-limiting exemplary application in which a beam-shaping and steering module could be used. Bio-optoelectronic systems could benefit from the stability offered by the adjustable optical mounts described herein. A beam-shaping and steering module, such as that described in FIG. 9, can be used in bio-optoelectronic systems to couple a beam of light from a laser to a bio-optoelectronic chip where molecules of interest are exposed to light for analysis. Bio-optoelectronic chips may include an array of optical components for isolating and detecting optical signals from molecules of interest. For example, arrays of waveguides may be included on a bio-optoelectronic chip for coupling light from an optical source outside the chip to a sample area on the chip, where the light may be used for measurements and/or analysis. The inventors have recognized and appreciated that for some applications, the performance of the bio-optoelectronic chip may depend on the stability of the excitation light or the precision with which it can be steered to the appropriate region on the chip for coupling into the appropriate waveguide. Accordingly, the inventors have recognized and appreciated that drift in the alignment of the optical components may introduce noise or errors into the on-chip measurement. Therefore, the inventors have developed adjustable optical mounts, which provide for an easily adjustable and stable optical mount, that may provide advantages to bio-optoelectrical systems by providing an easy way to correct alignment and a stable optical mount to resist optical drift.

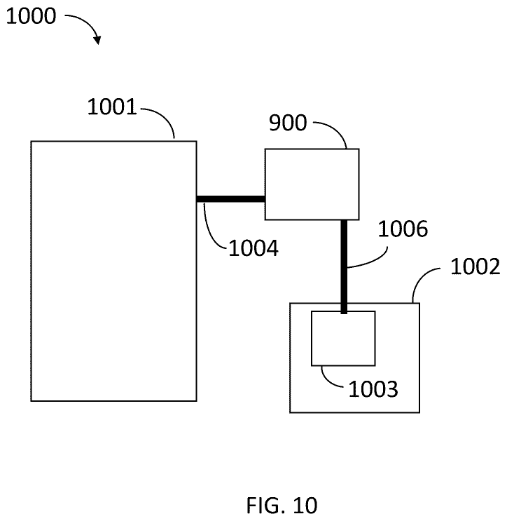

FIG. 10 illustrates a bio-optoelectronic system including a beam-shaping and steering module configured to couple light pulses from a pulsed laser to a bio-optoelectronic chip, in accordance with some embodiments described herein. Bio-optoelectronic system 1000 includes pulsed laser unit 1001 which is configured to generate laser pulse beam 1004 and a bio-optoelectronic chip 1003 configured to capture fluorescent signals indicative of the properties of a sample target molecule. To improve the coupling of light between the pulsed laser unit 1001 and bio-optoelectronic chip 1003, bio-optoelectronic system 1000 further includes a beam-shaping and steering module that is configured to receive beam 1004 as input light and further configured to transform the directionality and/or dimensionality of beam 1004 into excitation beam 1006. Excitation beam 1006 may then be used to probe molecules of interest by optically exciting fluorescent molecules at the bio-optoelectronic chip. The bio-optoelectronic chip 1003 may be further configured with a detection and/or control system 1002 which may transmit signals to the bio-optoelectronic chip to control its operation.

In some embodiments, the bio-optoelectronic chip may include one or more reaction chambers. Each reaction chamber may be configured to enable the interactions between a molecule of interest and fluorescent tags which may bind to a portion of the molecule of interest. One or more optical waveguides may be included to couple excitation light to the reaction chambers. The optical waveguides may include grating couplers for coupling the excitation light 1006 into the optical waveguide.

During operation of the bio-optoelectronic chip, the excitation light 1006 may be scanned over the surface of the bio-optoelectronic chip 1003, by the beam-shaping and steering module, to selectively couple the excitation light into different waveguides at different times. For example, the beam-shaping and steering module may steer the excitation light to a position corresponding to a first grating coupler configured to couple light into a first waveguide for exciting a first target molecule in a first sample chamber. Then, the beam-shaping and steering module may steer the excitation light to a second position corresponding to a second grating coupler configured to couple light into a second waveguide for exciting a second target molecule in a second sample chamber. In some embodiments, the steering process may be repeated until each target molecule of interest has been scanned. Additionally, or alternatively, the steering process may return to the first grating coupler to excite its respective target molecule for a repeated measurement. Additionally, or alternatively, following a chemical reaction between a target molecule and a reagent, the steering process may return the excitation beam to the grating coupler corresponding to the target molecule to provide excitation light for another measurement.

In addition to be below claims, the following concepts are disclosed herein.
A method of adjusting an optical component wherein adjustments to the vertical angle have a coupling with adjustments to the horizontal angle of 0.5% to 25%.
A method of adjusting an optical component, wherein a vertical sensitivity of the optical mount is determined by a tilt angle and the adjusting the vertical angle of the front plate further comprising rotating the front plate with a tilt angle configured such that the vertical sensitivity is between 0.05 and 1.5.
A beam-shaping and steering assembly for altering a beam of radiation, the assembly comprising an optical mount for adjusting the position of an optical component to adjust a pointing of an input beam into beam shaping and steering optics, the optical mount comprising:
   a first optical component mounted on a first optical mount comprising:
   a front plate comprising a front surface, a back surface, and a shaft, wherein the front surface is configured to support the first optical component, and the shaft extends from the back surface of the front plate; and
   a base comprising a bore, wherein the bore is configured to receive the shaft of the front plate such that the front plate is configured to rotate around an axis of rotation of the front plate that is aligned with the shaft.
The beam-shaping and steering assembly recited above, wherein:
   the base is configured to horizontally adjust the optical axis by rotating the base; and
   the front plate configured to vertically adjust the optical axis by rotating front plate relative to the base around the axis of rotation of the front plate.
The beam-shaping and steering assembly recited above, wherein the first optical mount further comprises:
   an adjustment screw set disposed in the base, the adjustment screw set comprising an adjustment screw and a threaded bushing;
   a first notch, formed in the shaft of the front plate, configured to receive the adjustment screw such that the adjustment screw contacts the first notch to cause the front plate to rotate when the adjustment screw tightened; and
   a second notch, opposing the first notch, configured to receive a spring, such that the spring is compressed between the second notch and the base when the adjustment screw is tightened.
The beam-shaping and steering assembly recited above, further comprising an actuator configured to rotate the adjustment screw.
The beam-shaping and steering assembly recited above, further comprising a second optical component mounted on a second optical mount, wherein the second optical mount is configured to receive an input beam reflected from the first optical component, wherein the first and second optical mounts are configured such that the pointing of positioning of an input beam is adjustable in two directions.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

The phrase “and/or,” as used herein in the specification and in the claims, should be understood to mean “either or both,” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The terms “substantially,” “approximately,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. An optical mount for adjusting the position of an optical component, the optical mount comprising:
a front plate comprising a front surface, a back surface, and a shaft, wherein the front surface is configured to support the optical component, and the shaft extends from the back surface of the front plate; and
a base comprising a bore, wherein the bore is configured to receive the shaft of the front plate such that the front plate is configured to rotate around an axis of rotation of the front plate that is aligned with the shaft.

2. The optical mount of claim 1, wherein the front surface is further configured to support the optical component such that an optical axis of the optical component is at an angle greater than 0 degrees and less than 90 degrees relative to the axis of rotation of the front plate.

3. The optical mount of claim 2, wherein the front surface is further configured to support the optical component such that the optical axis of the optical component is at an angle greater than 25 degrees and less than 65 degrees relative to the axis of rotation of the front plate.

4. The optical mount of claim 3, wherein:
the base is configured to horizontally adjust the optical axis by rotating the base; and
the front plate configured to vertically adjust the optical axis by rotating front plate relative to the base around the axis of rotation of the front plate.

5. The optical mount of claim 4, wherein a vertical sensitivity of the optical mount is determined by a tilt angle and the tilt angle is configured to provide the vertical sensitivity between 0.05 and 1.5.

6. The optical mount of claim 4, wherein the optical mount is configured to vertically adjust the optical axis with a coupling of 0.5% to 25% with horizontal adjustments.

7. The optical mount of claim 1, wherein the base further comprises a screw that is configured to cause the bore to clamp on the shaft and restrict movement of the shaft when tightened.

8. The optical mount of claim 1, wherein the base further comprises a set screw that is configured to restrict movement of the shaft when tightened.

9. The optical mount of claim 1, further comprising:
an adjustment screw set disposed in the base, the adjustment screw set comprising an adjustment screw and a threaded bushing;
a first notch, formed in the shaft of the front plate, configured to receive the adjustment screw such that the adjustment screw contacts the first notch to cause the front plate to rotate when tightened; and
a second notch, opposing the first notch, configured to receive a spring, such that the spring is compressed between the second notch and the base when the adjustment screw is tightened.

10. The optical mount of claim 1, wherein the front surface is configured to support the optical component such that an optical axis of the optical component is offset from the axis of rotation, and the front plate further comprises a clear aperture aligned with the optical axis and configured to transmit light through the front plate.

11. The optical mount of claim 1, wherein the base comprises at least one curved slot configured to accommodate a mounting screw and to enable the base to rotate around a vertical axis of rotation when the mounting screw is loose.

12. A method of manufacturing an optical mount, the method comprising:
forming a front plate comprising a front surface, a back surface, and a shaft, wherein the front surface is configured to support an optical component, and the shaft extends from the back surface of the front plate; and
forming a base comprising a bore, wherein the bore is configured to receive the shaft of the front plate such that the front plate is configured to rotate around an axis of rotation of the front plate that is aligned with the shaft.

13. The method of manufacturing of claim 12, further comprising:
forming the front plate such that the front plate is monolithic; and
forming the base such that the base is monolithic.

14. The method of manufacturing of claim 13, wherein the front plate is formed of aluminum.

15. The method of manufacturing of claim 13, wherein the front plate is formed of heat-treated stainless steel.

16. The method of manufacturing of claim 13, wherein the front plate is formed of titanium.

17. The method of manufacturing of claim 13, wherein the front plate is formed of heat-treated stainless steel with a thermal expansion coefficient less than 18×10⁻⁶/K.

18. The method of manufacturing of claim 12, further comprising forming the front surface to support the optical component such that an optical axis of the optical component is offset from the axis of rotation, and forming a clear aperture in the front plate to be aligned with the optical axis and configured to transmit light through.

19. The method of manufacturing of claim 12, wherein forming the front plate further comprises forming the front plate to support the optical component such that an optical axis of the optical component is at an angle greater than 0 degrees and less than 90 degrees relative to the axis of rotation of the front plate.

20. A method for adjusting the position of an optical component that is supported by an optical mount, the optical mount comprising a front plate, and a base configured to support the front plate, the method comprising:
adjusting a vertical angle of an optical axis of the optical component, relative to an axis of rotation of the front plate, by rotating the front plate relative to the base; and
adjusting a horizontal angle of the optical axis of the optical component, relative to an axis of rotation of the base, by rotating the base.
